(19) United States
(12) Patent Application Publication
(10) Pub. No.: US 2025/0154291 A1
(43) Pub. Date: May 15, 2025

(54) IN-SITU BROMINE REGENERATION PROCESSES FOR THE PRODUCTION OF BROMOBUTYL ELASTOMERS

(71) Applicant: ExxonMobil Technology and Engineering Company, Baytown, TX (US)

(72) Inventors: Sunny Jacob, Seabrook, TX (US); Joseph D. Penney, Baton Rouge, LA (US); Matthew C. Konderson, Baton Rouge, LA (US); Jacob J. Hay, Houston, TX (US); Darryl W. Averette, Baton Rouge, LA (US); Joseph A. Maier, Singapore (SG); Yanping He, Singapore (SG); Eric J. Wamsley, Baytown, TX (US)

(21) Appl. No.: 18/921,093

(22) Filed: Oct. 21, 2024

Related U.S. Application Data
(60) Provisional application No. 63/598,689, filed on Nov. 14, 2023.

(51) Int. Cl. C08C 19/14; C08C 19/16

(52) U.S. Cl. CPC C08C 19/14; C08C 19/16

(57) ABSTRACT

In some embodiments a process includes introducing an aqueous solution to a first hydrocarbon solvent to form an emulsion, wherein the aqueous solution comprises an oxidizing agent containing solution and a surfactant containing solution. The process further includes introducing a cement to the emulsion to form a first mixture within a reactor, wherein the cement comprises a butyl rubber elastomer and a second hydrocarbon solvent that is the same as or different than the first hydrocarbon solvent. The process further includes introducing a halogen source to the first mixture contained within the reactor to form a second mixture comprising a halobutyl rubber elastomer. The process further includes introducing a neutralizing agent with the second mixture to form a third mixture. The process further includes isolating the halobutyl rubber elastomer from the third mixture.

This application claims the benefit of U.S. Provisional Patent Application 63/598,689 filed 14 Nov. 2023 entitled “IN-SITU BROMINE REGENERATION PROCESSES FOR THE PRODUCTION OF BROMOBUTYL ELASTOMERS,” the entirety of which is incorporated by reference herein.

### FIELD

The present application relates to methods of forming halobutyl elastomers.

### BACKGROUND

Several processes for regenerating bromine in-situ during the production of bromobutyl rubber, using oxidizing reagents have been disclosed. Bromobutyl rubber manufactured utilizing such regenerative processes, where the by-product hydrogen bromide (HBr) is in-situ converted to molecular bromine, for example using hydrogen peroxide, hypochlorite, etc. experiences unacceptable levels of Mooney growth upon warehouse aging when compared with conventional bromination processes. It has also been observed that the Mooney growth of the bromobutyl produced by bromine regeneration methods can be suppressed using certain antioxidants. However, some of these antioxidants impart color or lack economical justification to use in typical bromobutyl rubber applications.

There is a need to improve the Mooney stability of bromobutyl elastomers and a need for regenerative halogenation processes where the resulting polymer has a reduced Mooney viscosity growth produced using a regenerative processes.

References for citing in an Information Disclosure Statement (37 C.F.R. 1.97(h)): ExxonMobil Ref. No. 2022EM136 (not yet published); US Pub. No. 2018/0334555.

### SUMMARY

The present application relates to methods of forming halobutyl elastomers.

In some embodiments a process includes introducing an aqueous solution to a first hydrocarbon solvent to form an emulsion, wherein the aqueous solution comprises an oxidizing agent containing solution and a surfactant containing solution. The process further includes introducing a cement to the emulsion to form a first mixture within a reactor, wherein the cement comprises a butyl rubber elastomer and a second hydrocarbon solvent that is the same as or different than the first hydrocarbon solvent. The process further includes introducing a halogen source to the first mixture contained within the reactor to form a second mixture comprising a halobutyl rubber elastomer. The process further includes introducing a neutralizing agent with the second mixture to form a third mixture. The process further includes isolating the halobutyl rubber elastomer from the third mixture.

In some embodiments, a process includes introducing an aqueous solution with a first organic solvent to form an emulsion, wherein the aqueous solution comprises an oxidizing agent and a surfactant. The process further includes introducing a cement with the emulsion to form a first mixture and containing the first mixture within a reactor, wherein the cement comprises a butyl rubber elastomer and a second hydrocarbon solvent. The process further includes introducing a halogen source to the first mixture contained within the reactor to form a second mixture, wherein the formation of the second mixture further comprises conducting a halogenation reaction. The halogenation reaction includes reacting the halogen source with the butyl rubber elastomer to form an initial halogenated butyl rubber elastomer and a hydrogen halide, reacting the hydrogen halide with the oxidizing agent to form a free halide, and continuing the halogenation reaction to produce additional halobutyl rubber elastomer. The process further includes introducing a neutralizing agent with the second mixture to form a third mixture. The process further includes isolating the initial halobutyl rubber elastomer and/or additional halobutyl rubber elastomer from the third mixture.

In some embodiments, a process includes introducing an aqueous solution to a first hydrocarbon solvent to form an emulsion, wherein the aqueous solution comprises an oxidizing agent and a surfactant. The process further includes introducing a cement to the emulsion to form a first mixture within a reactor, wherein the cement comprises a butyl rubber elastomer and a second hydrocarbon solvent that is the same as or different than the first hydrocarbon solvent. The process further includes introducing HBr to into the reactor containing the first mixture to form a second mixture comprising a halobutyl rubber elastomer. The process further includes introducing a neutralizing agent with the second mixture to form a third mixture. The process further includes isolating the halobutyl rubber elastomer from the third mixture.

In some embodiments, a process includes introducing an aqueous solution with a first organic solvent to form an emulsion, wherein the aqueous solution comprises an oxidizing agent and a surfactant. The process further includes introducing a cement with the emulsion to form a first mixture in a reactor, wherein the cement comprises a butyl rubber elastomer and a second organic solvent. The process further includes introducing a halogen source with the first mixture contained in the reactor to form a second mixture such that the molar ratio of oxidizing agent to halogen is about 0.2:1 to about 0.8:1. Forming the second mixture further includes conducting a halogenation reaction comprising reacting the halogen source with the butyl rubber elastomer to form an initial halogenated butyl rubber elastomer and a hydrogen halide, reacting the hydrogen halide with the oxidizing agent to form a free halide, and continuing the halogenation reaction to produce additional halobutyl rubber elastomer. The process further includes introducing a neutralizing agent with the second mixture to form a third mixture. The process further includes isolating the initial halobutyl rubber elastomer and/or the additional halobutyl rubber elastomer from the third mixture to form a waste mixture, wherein the waste mixture comprises about 2,000 mg/L to about 2,650 mg/L of dissolved solids.

### BRIEF DESCRIPTION OF THE FIGURES

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally effective aspects.

FIG. 1 is a diagram illustrating butyl rubber formation, according to some embodiments.

FIG. 2 is a diagram illustrating a solvent replacement process, according to some embodiments.

FIG. 3 is a diagram illustrating halogenation and neutralization of cement to form halobutyl rubber, according to some embodiments.

FIG. 4 is a diagram illustrating water/hydrocarbon emulsion from halogenation and neutralization section routing to a flash drum, according to some embodiments.

FIG. 5 is a diagram illustrating finishing of crumbs, according to some embodiments.

To facilitate understanding, identical reference numerals have been used, where possible, to designate identical elements that are common to the figures. The figures are not drawn to scale and may be simplified for clarity. It is contemplated that elements and features of one aspect may be beneficially incorporated in other aspects without further recitation.

### DETAILED DESCRIPTION

The present disclosure involves methods for eliminating or inhibiting Mooney viscosity growth (alternatively described as increasing Mooney viscosity stability) over a period of time, which can often occur in halogenated (brominated) polymers, particularly those made using a regenerative halogenation (bromination) process. Regenerative halogenation processes disclosed herein provides halobutyl elastomers with comparable Mooney viscosity growth and physical property retention to elastomers formed from conventional halogenation processes. In particular, it was found that surfactant plays a role in promoting H₂O₂ conversion in regenerative halogenation processes through increasing the surface area between the aqueous and organic phases. Processes disclosed herein allow for low residence times and high concentrations of halogenated cement without affecting the Mooney stability of the halobutyl elastomers. Without being bound by theory, the surfactant assists in forming a more stable dispersion of an aqueous phase in a continuous hydrocarbon phase (e.g., heterophasic mixture) within the halogenation reactor. Thus, aqueous H₂O₂ is able to be well dispersed within the continuous hydrocarbon phase (e.g., cement). Additionally, a more stable dispersion allows for increased surface areas between the aqueous and hydrocarbon phases, which in turn promotes migration of HBr from the hydrocarbon phase to the aqueous phase for halogen regeneration, via oxidation of HBr with H₂O₂, leading to increased halogenation of aliphatic elastomers using less halogen reactants.

### Definitions

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

“Diluent” means a diluting or dissolving agent. Diluent is specifically defined to include chemicals that can act as dissolving agents, e.g., solvents, for the Lewis Acid, other metal complexes, initiators, monomers, or other additives, but which preferably do not act as dissolving agents for the elastomer obtained through polymerization of the dissolved monomers. The diluent does not alter the general nature of the components of the polymerization medium, e.g., the components of the catalyst system, monomers, etc. However, it is recognized that interactions between the diluent and reactants may occur. In preferred embodiments, the diluent does not react with the catalyst system components, monomers, etc., to any appreciable extent. Additionally, the term diluent includes mixtures of at least two or more diluents. Diluents, in the practice of the present disclosure, are generally hydrocarbon liquids, which may be halogenated with chlorine or fluorine as disclosed in U.S. Pat. No. 7,232,872.

“Solvent” means a hydrocarbon liquid that is capable of acting as a dissolving agent for an elastomeric polymer. Solvents, in the practice of the present disclosure, are generally hydrocarbon liquids having the formula CxHy, wherein x is 5 to 20, and y is 12 to 22, such as hexane, isohexane, pentane, iso-pentane, and cyclohexene.

“Polymer(s)” means any homopolymer, copolymer, terpolymer, etc. Likewise, “copolymer(s)” means any polymer comprising at least two monomers, optionally with other monomers. When a polymer is referred to as comprising a monomer, the monomer is present in the polymer in the polymerized form of the monomer or in the polymerized form of a derivative from the monomer (e.g., a monomeric unit). However, for ease of reference the phrase comprising the (respective) monomer or the like is used as shorthand. Likewise, when catalyst components are described as comprising neutral stable forms of the components, it is well understood by one skilled in the art, that the ionic form of the component is the form that reacts with the monomers to produce polymers.

“Elastomer(s)” means any polymer or composition of polymers consistent with the ASTM D1566 definition of “a material that is capable of recovering from large deformations, and can be, or already is, modified to a state in which it is essentially insoluble, if vulcanized, (but can swell) in a solvent.” Elastomers are often also referred to as rubbers. The term elastomer may be used herein interchangeably with the term rubber. Preferred elastomers have a melting point that cannot be measured by DSC or if it can be measured by DSC is less than about 40° C., or preferably less than about 20° C., or less than about 0° C. Preferred elastomers have a glass transition temperature (Tg) of about −50° C. or less as measured by DSC.

“Mooney viscosity” or “viscosity” means the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646. Mooney viscosity is measured in Mooney units.

For purposes of this disclosure, the numbering scheme for the Periodic Table Groups is according to the IUPAC Periodic Table of Elements.

The term “and/or” as used in a phrase such as “A and/or B” herein is intended to include “A and B,” “A or B,” “A,” and “B.”

The terms “substituent,” “radical,” “group,” and “moiety” may be used interchangeably.

As used herein, and unless otherwise specified, the term “Cₙ” means hydrocarbon(s) having n carbon atom(s) per molecule, wherein n is a positive integer.

As used herein, and unless otherwise specified, the term “hydrocarbon” means a class of compounds containing hydrogen bound to carbon, and encompasses (i) saturated hydrocarbon compounds; (ii) unsaturated hydrocarbon compounds; and (iii) mixtures of hydrocarbon compounds (saturated and/or unsaturated), including mixtures of hydrocarbon compounds having different values of n.

For purposes of this disclosure and claims thereto, unless otherwise indicated, the term “substituted” means that a hydrogen group has been replaced with a heteroatom, or a heteroatom containing group. For example, a “substituted hydrocarbon” is a hydrocarbon made of carbon and hydrogen where at least one carbon (and attendant hydrogen(s)) and/or at least one hydrogen is replaced by a heteroatom or heteroatom containing group.

As used herein, the term “isoolefin” refers to any olefin monomer having at least one carbon having two substitutions on that carbon. As used herein, the term “multiolefin” refers to any monomer having two (e.g., “diolefin”) or more double bonds (e.g., “triolefin,” etc.). In some embodiments, the multiolefin is any monomer comprising at least two conjugated double bonds, such as a conjugated diene (like isoprene).

The phrases “isobutylene based elastomer” or “isobutylene based polymer” refer to elastomers or polymers comprising at least 70 mol % repeat units from isobutylene. Further, the term “butyl” is used interchangeably with the phrase “isobutylene based” herein.

### Elastomers and Components Thereof

Elastomers useful in the practice of the present disclosure include a) polymers derived from at least one C₄ to C₇ isoolefin monomer and at least one multiolefin monomer and b) homopolymers of C₄ to C₇ isoolefin monomers. For the copolymers, the isoolefin derived content in the copolymer is in a range from about 70 wt % to about 99.5 wt % of the total monomer derived units in one embodiment, such as about 85 wt % to about 99.5 wt %. The total multiolefin derived content in the copolymer is present in the range of mixture from about 0.5 wt % to about 30 wt %, such as about 0.5 wt % to about 15 wt %, such as about 0.5 wt % to about 12 wt %, such as about 0.5 wt % to about 8 wt %. Herein for the purpose of the present disclosure, multiolefin refers to any monomer having two or more double bonds. In a preferred embodiment, the multiolefin is any monomer comprising two conjugated double bonds and may be an aliphatic or aromatic monomer.

The C₄ to C₇ isoolefin may be selected from compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, alkylstyrene, and piperylene, and other monomers such as disclosed in U.S. Pat. No. 5,506,316.

The elastomer may also be a random copolymer having one or more C₄ to C₇ isoolefins derived units and one or more alkylstyrene derived units. In some embodiments, the random copolymer includes about 85 wt % to about 93.9 wt % of the isoolefin units, such as about 86.9 wt % to about 93.5 wt %. In some embodiments, the random copolymer includes about 5 wt % to about 12 wt % alkylstyrene units, and about 1.1% to about 1.5 wt % of a halogen. In one or more embodiments, the polymer may be a random elastomeric copolymer of a C₄ to C₇ α-olefin and a methylstyrene containing at about 8 wt % to about 12 wt % methylstyrene. The poly(isobutylene-co-p-methylstyrene) polymers are also referred to as IMSM polymers.

Other C₄ to C₇ isoolefin derived unit-containing elastomers suitable for use in the present disclosure include terpolytners comprising the isoolefin and two multiolefins wherein the multiolefins have different backbone structures prior to polymerization. Such terpolymers include both block and random terpolymers of C₄ to C₈ isoolefin derived units, C₄ to C₁₄ multiolefin derived units, and alkylstyrene derived units. One such terpolymer may be formed form isobutylene, isoprene, and alkylstyrene, preferably methylstyrene, monomers. Another suitable terpolymer may be polymerized from isobutylene, cyclopentadiene, and alkylstyrene monomers. Such terpolymers are obtained under cationic polymerization conditions.

Thus, polymers useful herein can be described as copolymers of a C₄ isomonoolefin derived unit, such as an isobutylene derived unit, and at least one other polymerizable unit with non limiting examples of isobutylene-based elastomers including poly(isobutylene), butyl rubber (isoprene-isobuty)ene rubber, “IIR”), branched (“starbranched”) butyl rubber, star-branched polyisobutylene rubber, block terpolymers of isoprene-isobutylene-styrene, random copolymers of isobutylene and para-methylstyrene, and random terpolymers of isobutylene, isoprene, and paramethyl styrene.

In some embodiments, the elastomer is an isobutylene based elastomer obtained by reacting about 92 wt % to about 99.5 wt % of isobutylene with about 0.5 wt % to 8 wt % isoprene, or about 95 wt % to 99.5 wt % isobutylene with about 0.5 wt % to about 5.0 wt % isoprene. Such copolymers derived from isobutylene and isoprene are commonly referred to as butyl rubbers.

High purity isobutylene (typically about 95 wt % to about 100 wt %) and isoprene (such as about 95 wt % to about 99.9 wt %) can be used for the manufacture of butyl rubber. Impurities can have an impact on isobutylene/isoprene conversion, polymer molecular weight distribution, and reactor performance. The monomer purity is controlled by purchase specifications and stringent quality control with additional purification completed at the production unit if desired. High purity isobutylene can be derived from fossil fuels, advanced recycling processes, or bio based sources.

The above polymers may be produced by any suitable polymerization. The polymers can be produced in either a slurry polymerization process or a solution polymerization process. If the polymer is produced in a slurry polymerization process where the polymer precipitates out of the reaction medium, then the polymer is dissolved into a suitable solvent, e.g., the creation of a polymer cement, prior to halogenation. For polymers produced via a solution process, after removal of unreacted monomers and removal or neutralization of unused catalysts, the same polymer containing solution, or polymer cement, may be used for halogenation. The polymer cement can contain about 1 wt % to about 70 wt % polymer, such as about 10 wt % to about 60 wt % polymer, such as about 10 wt % to about 50 wt % polymer, such as about 10 wt % to about 40 wt % polymer, such as about 20 wt % to about 30 wt %.

In some embodiments, elastomers of the present disclosure can include a weight average molecular weight (M_{w}), as determined by gel permeation chromatography (GPC), of about 380 kDa to about 2,000 kDa, such as about 390 kDa to about 1,000 kDa, such as about 400 kDa to about 850 kDa, such as about 425 kDa to about 750 kDa, such as about 450 kDa to about 650 kDa. In some embodiments, elastomers of the present disclosure can be characterized by a narrow molecular weight distribution (MWD), as determined by GPC, such as about 1.01 to about 5, such as about 2 to about 5, such as about 2.5 to about 4.5.

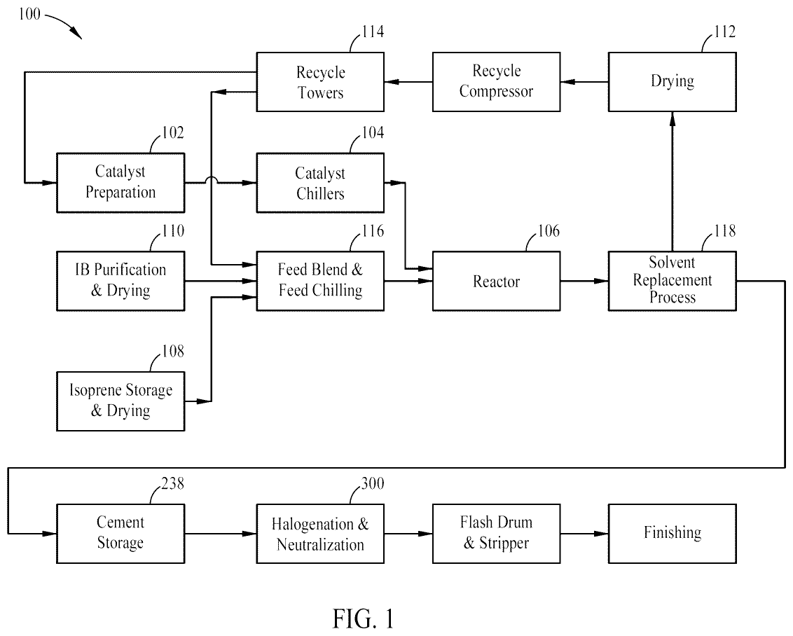

The high purity diluent (typically about 98 wt % to about 100 wt %) used for catalyst diluent from a diluent recovery tower is combined with the initiator and then the catalyst. The initiator is typically HCl, the catalyst is typically either aluminum alkyl catalyst or aluminum chloride catalyst. FIG. 1 is a diagram 100 illustrating butyl rubber formation. When an aluminum alkyl catalyst is used, the catalyst diluent and catalyst are combined at 102 and mixed with static mixers to ensure good distribution. When aluminum chloride catalyst is used, the catalyst diluent stream is split and one portion of the catalyst diluent is chilled at 104 and sent through aluminum chloride dissolving bed(s) and subsequently recombined with the other portion of the catalyst diluent to achieve the desired catalyst concentration. The catalyst/diluent/initiator stream is injected into the reactor(s) 106 at a high velocity to ensure good distribution in the reactor, such as about 1.5 m/s to about 5 m/s. The catalyst to initiator ratio can be about 1 mol/mol to about 5 mol/mol, such as about 1.5 to about 2.5 mol/mol.

The reaction is sensitive to oxygenated compounds, oxygen and moisture. Moisture is removed from fresh isoprene at 108 and isobutylene at 110 before being sent to the reactor 106. The diluent/monomer recycle stream is dried at 112 with fixed bed alumina and/or molecular sieve driers to remove residual moisture and oxygenated compounds. The recycled solvent stream is dried at 114 with fixed bed molecular sieve driers or by fractionation before reuse in the process. The recycle streams and raw material streams are fitted with moisture analyzers, oxygen analyzers, and oxygenate analyzers to assure moisture, oxygen and oxygenate levels are controlled. Light ends including oxygen are purged from the diluent recovery tower distillate drum.

### Feed Blend and Reactors

Isobutylene and isoprene in diluent are prepared to a predetermined composition in a feed blend drum at 116, chilled to −90° C. to −100° C. using a series of heat exchangers and fed to reactor(s) 106. A catalyst and co-catalyst are prepared in high purity diluent and fed to the reactor(s) 106. A copolymer of isobutylene and isoprene is made in the reactor(s) 106. An example diluent used is methyl chloride. In some embodiments, the feed blend contains about 20 wt % to about 40 wt % isobutylene and about 0.4 wt % to about 1.4 wt % isoprene depending on the grade with the remainder being mainly diluent.

Butyl reactors foul with time and are taken out of service periodically to be cleaned. The butyl reaction process can thus be a semi batch process with a number of reactors producing and a number of reactors in non-production mode. At the end of the production cycle the producing reactor is quenched by injecting alcohol or water into the reactor to stop the reaction and then flushed with diluent at a temperature of about −40° C. to −80° C. to remove the bulk of the rubber slurry and gradually warm the reactor. Solvent is introduced to further warm the reactor up to 0° C. to 50° C. The reactor 106 is then washed with solvent at a temperature of 0° C. to 90° C. to remove the rubber foulant that has accumulated on the vessel surface. When the reactor 106 is clean, the solvent is displaced with diluent at −40° C. to −80° C. to gradually cool the reactor down and then chilled down to −90° C. to −100° C. in preparation for production. The flow rates, temperatures, and duration of each of the non-production stages are managed to ensure the mechanical design conditions of the reactor and reactor pump are not compromised.

When the reactor 106 is chilled for production, the reactor 106 is primed with a mixture of diluent, isobutylene, and isoprene. The diluent isobutylene and isoprene concentrations are set to emulate the normal background concentrations during reactor production to ensure the polymer is quickly at specification. The initiator and co-initiator are then injected at high rates to ensure the reaction initiates rapidly before being set to normal rates to assure the rubber is at specification.

### Solvent Replacement Process

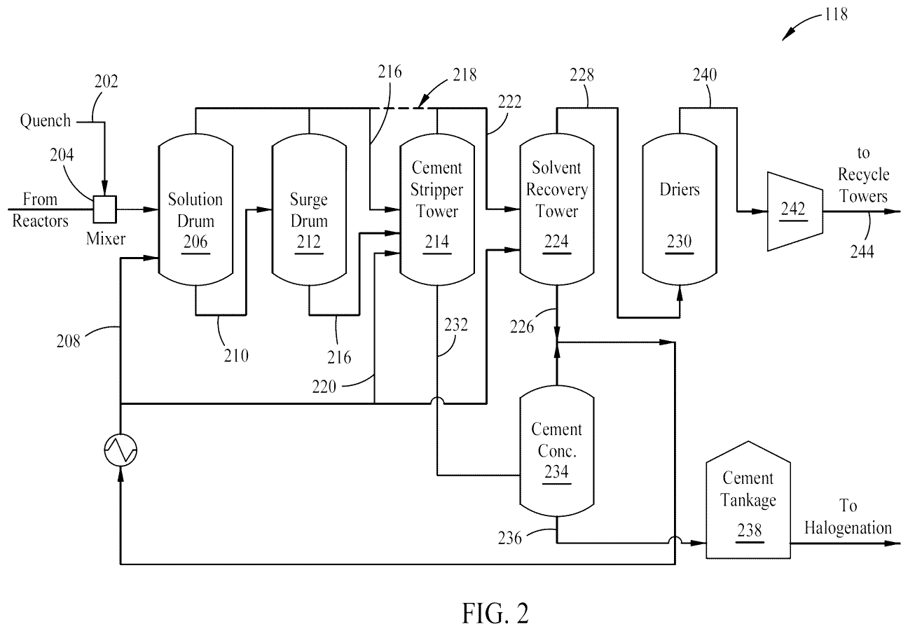

An alcohol or water quench is injected into the reactor overflow outlet to quench the catalyst at 118, e.g., as described in U.S. Pat. No. 4,154,924 incorporated by reference herein. FIG. 2 is a diagram illustrating solvent replacement process 118. As shown in FIG. 2, quench 202 may be premixed with polar diluent and may then be diluted with solvent, with or without a static mixer, before adding quench 202 to the reactor outlet. The quench 202 is injected and mixed at 204 with the reactor slurry with or without a mechanical mixer. The resulting stream is then routed to a solution drum 206 where solvent vapor 208 is added to heat and dissolve the polymer to make a polymer/solvent solution known as cement. A typical solvent can be a mixture of normal hexane and isomers of hexane. The solution drum liquid outlet 210 is then routed to a surge drum 212. The solution drum 206 and surge drum 212 may be combined into a single drum. The solution may be sampled and analyzed periodically to monitor polymer properties. Statistical Process Control techniques and fundamental or empirical models may be used to monitor product quality and guide optimization of polymerization conditions. The drum(s) operating temperatures can be about −20° C. to about +30° C., such as about −20° C. to about +10° C. and the operating pressures can be about 0 kPag to about 1000 kPag, such as about 0 kPag to about 500 kPag. The process is operated to generate a vapor stream of about 0% to about 30% of the total drum feed, e.g., as described in U.S. Pat. No. 3,257,349 incorporated by reference herein. The liquid stream from these drums having cement/solvent/diluent/unreacted monomers is routed to a cement stripping tower 214 via line 216. The vapor stream having solvent/diluent/unreacted monomers from the drums 206 and 212 is routed to either the cement stripping tower 214 via line 216 or the cement stripping tower overheads via line 218. Solvent vapor is injected at the bottom of the tower via line 220 and flows counter currently to the cement. The cement stripping tower overheads having diluent, unreacted monomers, and a portion of the solvent is routed via line 222 to a solvent recovery tower 224 where high purity solvent is recovered in the bottoms stream (line 226) for recycle and diluent, unreacted monomers are recovered in the overheads (line 228) and sent to the diluent recycle stream driers 230. The diluent/monomers recycle stream (line 240) from the solvent replacement process section is dried using a combination of fixed bed alumina and chloride resistant molecular sieve driers 242 to remove moisture. The diluent/monomers stream 244 is sent to recycle towers to separate and recover diluent and monomers for reuse in the process.

The cement stripping tower 214 is operated to ensure that the monomer concentration is very low in the cement stream as any monomers could react in subsequent halogenation processes and exceed desired product specifications (e.g., industrial hygiene control). The monomer concentration in the cement stream (line 232) is <200 wtppm and typically <50 wtppm for good industrial hygiene control.

The bottoms cement stream (line 232) from the cement stripping tower 214 is flashed into 1-2 cement concentrator drums 234. The cement is cooled and the cement concentration increased. The cement concentrator overheads vapor stream (line 234) has a temperature that is determined by the utilities temperature, typically cooling water or air. The operating pressure of the concentrator drum(s) 234 is determined by the solvent vapor pressure curve, the typical solvent is a mixture of normal hexane and isomers of hexane. The cement concentrator(s) 234 are operated at a pressure of about 40 kPaa to about 150 kPaa, such as about 50 kPaa to about 100 kPaa, e.g., as described in U.S. Pat. No. 3,257,349, incorporated herein by reference. The cement concentrator drum 234 is fitted with side to side trays or baffle plates (shower deck) that allow the solvent vapor to separate from the viscous cement and minimize vapor entrainment in the bottoms cement stream (line 236). The overheads solvent from the cement concentrator is recycled in the process. The bottoms cement stream (line 236) is sent to storage 238. The cement concentration sent to storage 238 is about 18 wt % to about 30 wt %, such as about 22 wt % to about 28 wt %. Heat integration is used extensively in the solvent recovery part of the plant and the reslurry part of the unit to promote energy efficiency.

### Bromination and Regeneration Process

Preparing butyl elastomers via conventional bromination is described in detail in, for example, U.S. Pat. Nos. 2,356,128, 4,474,924, 4,068,051, 7,232,872, and 7,414,101, each of which is incorporated herein by reference. As disclosed in these references, the monomers and catalysts are dissolved in a hydrocarbon diluent in which the polymerization occurs. If the polymerization is a slurry polymerization, the diluent is selected such that the resulting polymer will precipitate out of the diluent upon formation. Slurry polymerization conventionally yields a slurry containing 10 to 70 wt % solids in the slurry. Following polymerization, for both solution polymerization (wherein the polymer remains dissolved in the solvent) and slurry polymerization, the polymer must be recovered from the solvent. This is typically done in a flash drum, followed by washing and drying of the polymer to yield a rubber crumb suitable for baling and packaging.

Halogenation of the dissolved polymer is carried out by adding bromine to a polymer cement solution. Halogenation of isobutylene copolymers is also described in U.S. Pat. No. 5,670,582, incorporated herein by reference. The halogen wt % in the formed elastomer is from 0.1 to 10 wt % based on the weight of the halogenated elastomer in one embodiment, and from 0.5 to 5 wt % in another embodiment. In yet another embodiment, the halogen wt % of the halogenated rubber is from 1.0 to 2.5 wt %.

After halogenation, the solution is subjected to a neutralization step wherein HBr is reacted with an aqueous caustic solution to yield a soluble salt in an aqueous phase. Following neutralization, some or all of the aqueous phase may be optionally removed prior to removal of the hydrocarbon solvent in which the halogenated elastomer is still dissolved. For such water removal, the temperature of the solution should not exceed 100° C. or the properties of the final halogenated polymer may be negatively affected. After the neutralization step, a free radical scavenger can be added to the bromobutyl elastomers according the present disclosure.

The isobutylene-based polymer is then finished by stripping the solvents from either the slurry or the solution and drying of the resulting solid polymer into a crumb form that may be baled or packaged. The drying is conventionally accomplished using continuous helical path extruders wherein, as the polymer passes through the extruders, the elastomer solids are masticated and the water is squeezed or evaporated out of the mixture by the helical blades of the extruder.

Isobutylene based polymers having unsaturation in the polymer backbone, such as isobutylene-isoprene polymers, may be readily halogenated using an ionic mechanism during contact of the polymer with a halogen source, e.g. molecular bromine or chlorine, and at temperatures in the range of from about 20° C. to about 80° C. Isobutylene based polymers having no unsaturation in the polymer backbone, such as isobutylene-alkylstyrene polymers, can undergo halogenation under free radical halogenation conditions, e.g. in the presence of white actinic light or by inclusion of an organic free radical initiator in the reaction mixture at about 20° C. to about 90° C.

Regenerative halogenation processes can occur by contacting a polymer solution with a halogenating agent and an emulsion containing an oxidizing agent. The oxidizing agent can interact with hydrogen halide created during halogenation, converting the halogen back into a form useful for further halogenation of the polymer thereby improving the halogen utilization (for example converting HBr back into Br₂).

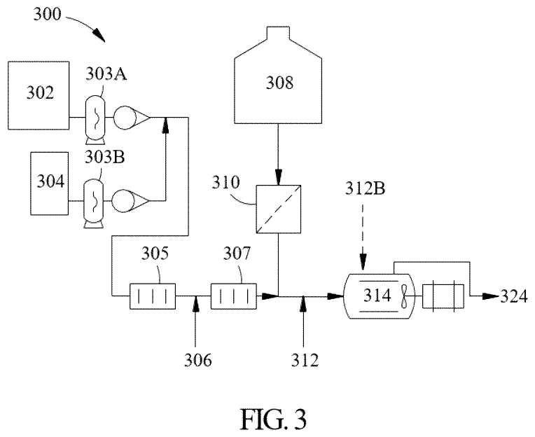

Halogenation and neutralization can be performed using any suitable process. FIG. 3 is a diagram 300 illustrating halogenation and neutralization of cement to form halobutyl rubber. In some embodiments, processes disclosed herein are continuous processes. As shown in FIG. 3, a solution including an oxidizing agent 302 and a solution including a surfactant 304 are pumped, via pumps 303A and 303B respectively, to a mixing system 305 to form an aqueous phase. The mixing system 305 can include one or more static or mechanical mixing apparatuses, such as a static mixing apparatus. A solvent 306 is added in line to the aqueous phase and is mixed in a mixing system 307 to form an emulsion. The mixing system 307 can include one or more static or mechanical mixing apparatuses, such as a static mixing apparatus.

Oxidizing agents useful in a process of the present disclosure are materials which contain oxygen, such as water soluble oxygen containing agents. Suitable agents include peroxides and peroxide forming substances. In some embodiments, the oxidizing agent is selected from hydrogen peroxide, organic hydrogen peroxide, sodium chlorate, sodium bromate, sodium hypochlorite or bromite, oxygen, oxides of nitrogen, ozone, urea peroxidate, acids such as pertitanic perzirconic, perchromic, permolybdic, pertungstic, perunanic, perboric, perphosphoric, perpyrophosphoric, persulfates, perchloric, perchlorate, periodic acids, or combinations thereof. Of the foregoing, hydrogen peroxide and hydrogen peroxide-forming compounds, e.g., per-acids and sodium peroxide, have been found to be highly suitable for carrying out halogen regeneration. In at least one embodiment, the oxidizing agent is hydrogen peroxide.

In some embodiments, the solution including an oxidizing agent 302 is a mixture of water and the oxidizing agent, wherein the oxidizing agent is about 10 wt % to about 60 wt % of the solution 302, such as about 20 wt % to about 50 wt %, such as about 30 wt % to about 40 wt %.

In some embodiments, the solution 304 is a surfactant, a surfactant mixture, or an aqueous solution thereof. When the surfactant 304, or solution thereof, is combined with oxidizing agent solution 302 to form the aqueous phase, the surfactant 304 is about 0.1 wt % to about 5 wt % of the aqueous phase, such as about 0.2 wt % to about 4 wt %, such as about 0.3 wt % to about 3 wt %, such as about 0.5 wt % to about 2 wt %. In some embodiments, the surfactant is a nonionic surfactant, such as an ethoxylated alcohol emulsifying agent, such as octyl phenol ethoxylate, ethoxy tridecyl alcohol, polysorbate 80, a poloxamer, and combinations thereof. In at least one embodiment, the surfactant can include any one or more nonionic surfactants known to one of ordinary skill in the art.

In at least one embodiment, the volume and flow rate of solutions 302 and 304 can be controlled via pumps 303A and 303B. The volume ratio of the two components can be expressed in terms of the weight ratio of surfactant to oxidizing agent (lbs surfactant/100 lbs of oxidizing agent). In some embodiments, the aquoues phase comprises about 1 lbs surfactant/100 lbs of oxidizing agent to about 3.8 lbs surfactant/100 lbs of oxidizing agent, such as about 1.5 lbs surfactant/100 lbs of oxidizing agent to about 3.5 lbs surfactant/100 lbs of oxidizing agent, such as about 2 lbs surfactant/100 lbs of oxidizing agent to about 3 lbs surfactant/100 lbs of oxidizing agent. In some embodiments, the oxidizing agent is H₂O₂.

In at least one embodiment, a solvent 306 can be any solvent suitable for use or used in forming the polymer cement. In one embodiment, the solvent is selected to be the same solvent used to form the polymer cement. Suitable solvents include hydrocarbons such as pentane, hexane, heptane, and the like, inert halogen containing hydrocarbons such as mono-, di-, or tri-halogenated C₁ to C₆ paraffinic hydrocarbon or a halogenated aromatic and/or aliphatic hydrocarbons such as dichloroethane, n-butyl chloride, and monochlorobenzene or mixtures of the hydrocarbons and one or more inert halo-hydrocarbon solvents, such as methyl chloride, methylene chloride, ethyl chloride, and/or ethyl bromide. Furthermore, the solvent may be a combination of the solvents provided herein, including isomers thereof.

In some embodiments, the emulsion formed by combining the solvent 306 and the aqueous phase includes a volume ratio of the solvent to the aqueous phase of about 40:1 to about 1:1, such as about 20:1 to about 1.5:1, such as about 10:1 to about 2:1.

The cement from storage 308 (which corresponds the cement storage 238 of FIG. 2) is pumped through a series of filters, such as ceramic filters including pore sizes of about 400 μm to about 600 μm, and added in-line with the emulsion in a well-mixed halogenation reactor 314 where a halogen source, such as Br₂, Cl₂, NaBr, NaCl, or combinations thereof, is added via line 312 to form halobutyl rubber. In at least one embodiment, the series of filters is configured to prevent solid particles, such as rust particles, from entering the halogenation system. The halogen can be vapor chlorine or liquid bromine depending on the grade of halobutyl rubber being made, such as liquid bromine. The halogenation reactor 314 can be a CSTR (continuous stirred tank reactor) or a high speed mixing device such as a CONTACTOR™ from STRATCO™. In some embodiments, reactor vessel is a mixed flow stirred tank, a conventional stirred tank, a packed tower, or a pipe with sufficient flow and residence time to permit the desired reaction to occur.

In some embodiments, the cement supplied to the halogenation reactor 314 is controlled such that the concentration of rubber present therein is about 20 wt % to about 35 wt %, such as about 22 wt % to about 30 wt %, such as about 24 wt % to about 30 wt %.

In some embodiments, the peroxide to bromine ratio (mol:mol) is about is about 0.2:1 to about 0.8:1, such as about 0.4:1 to about 0.7:1, such as about 0.4:1 to about 0.6:1. In one or more additional or alternative embodiments, the bromine to rubber ratio is about 18 kg/Ton to about 45 kg/Ton, such as about 25 kg/Ton to about 45 kg/Ton, such as about 25 kg/Ton to about 35 kg/Ton, such as about 25 kg/Ton to about 30 kg/Ton.

The residence time of the halogenation reaction is about 0.5 min to about 60 min, such as about 0.5 min to about 25 min, such as about 1 min to about 10 min, such as about 1 min to about 5 min, such as about 2 min to about 3 min. In some embodiments, the halogenation reaction temperature is about 20° C. to about 70° C., such as about 30° C. to about 65° C., such as about 40° C. to about 60° C.

In some embodiments, the bromine utilization of the halogenation reaction is about 60% to about 90%, such as about 65% to about 85%, such as about 70% to about 80%. In some embodiments, the H₂O₂ conversion of the halogenation reaction is about about 60% to about 99.9%, such as about 65% to about 99%, such as about 70% to about 95%.

Since a considerable portion of the hydrogen halide, such as hydrogen bromide, generated in situ as a halogenation process by-product is oxidized to regenerate useful halogen, smaller amounts of halogenating agent are initially required to achieve a given degree of polymer halogenation than would be the case where the reaction is conducted without the use of oxidizing agent. As a general rule, the amount of halogenating agent present in the reaction media may vary between about 0.1 php to about 10 php (parts by weight per 100 parts by weight polymer), such as about 0.2 php to about 6 php, such as about 0.2 php to about 5 php.

In some embodiments, the halogen source may be added directly to the halogenation reactor 314 from an external source via line 312B. In one or more embodiments, the halogen source added to the halogenation reactor 314 via line 312B is HBr and/or any form thereof. The HBr halogen source can be introduced to the halogenation reactor 314 via line 312B as HBr gas or an ageous solution of HBr. In at least one embodiment, the halogen source is an aqueous HBr solution having about 20 vol % to about 90 vol % of HBr, such as about 30 vol % to about 70 vol %, such as about 40 vol % to about 50 vol %.

After completion of the halogenation reaction, the polymer is recovered (line 324) by one or more techniques known to one of ordinary skill in the art, such as neutralization with dilute caustic, water washing, and removal of solvent such as by steam stripping techniques or by precipitation using a lower alcohol such as isopropanol. For example, the process detailed in U.S. Pat. No. 5,670,582 is incorporated herein by reference.

In one or more embodiments, polymer and reaction by-products (line 324) are mixed with a neutralizing agent, such as sodium hydroxide, to neutralize the resultant HCl or HBr/bromine. Once neutralized, a stabilizing additive may be added to thereto to form a stable emulsion. In some embodiments, the additive is a calcium stearate dispersion with a surfactant. In some embodiments, a surfactant is a non-ionic alcohol ethoxylate, such as ethoxy tridecyl alcohol. The final neutralization stage may include one or more individual process units, such as about one to about four individual process units individually selected from, but not limited to, a CSTR, a CONTACTOR™, a static mixer, or a combination thereof.

In some embodiments, the stabilizing additive is calcium stearate, calcium palmitate, zinc stearate, zinc palmitate. In some embodiments, the stabilizing additive is an alcohol such has Imbentin T/070 (made by KLK Oleo), Synperonic 13/7-85 (made by Croda, previously known as Volpo X078), Tergitol 15-5-7 (made by Dow), or Genapol X050 (made by Clariant). In some embodiments, the stabilizing additive is a low critical solution temperature (LCST) material, such as those described in U.S. Pat. No. 10,611,886 (incorporated herein by reference), such as poly(N-isopropylacrylamide), poly(N-isopropylacrylamide-co-N,N-dimethylacrylamide, poly(N-isopropylacrylamide)-alt-2-hydroxyethylmethacrylate, poly(N-vinylcaprolactam, poly(N,N-diethylacrylamide), poly[-(dimethylamino)ethyl methacrylate], poly(2-oxazoline) glyclastomers, Poly(3-ethyl-N-vinyl-2-pyrrolidone), hydroxybutyl chitosan, polyoxyethylene (20) sorbitan monostearate, polyoxyethylene (20) sorbitan monolaurate, polyoxyethylene (20) sorbitan monooleate, methyl cellulose, hydroxypropyl cellulose, hydroxyethyl methylcellulose, hydroxypropyl methyl cellulose, poly(ethylene glycol) methacrylates with 2 to 6 ethylene glycol units, or polyethyleneglycol-co-polypropylene glycols, such as those with 2 to 6 ethylene glycol units and 2 to 6 polypropylene units.

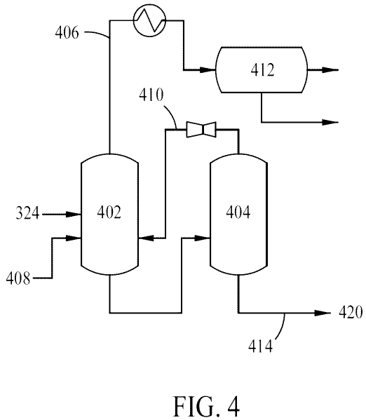

FIG. 4 shows water/hydrocarbon emulsion from the halogenation and neutralization section (line 324) is routed to flash drum 402 to remove and recover the solvent (line 406). The water/hydrocarbon emulsion is flashed into an agitated flash drum 402 where steam is injected into the liquid to strip the solvent from the stream. A rubber crumb is formed in the flash drum 402, an additive (line 408) is added to the flash drum 402 to prevent polymer agglomeration and vessel plugging. The additive is typically calcium stearate dispersion with a surfactant. The water/crumb mixture flows to an agitated stripper 404 where additional residence time and reduced pressure allows the solvent to diffuse from the crumb to the vapor stream (line 410). Additional steam may be injected into the stripper 404 to aid the solvent diffusion process. Water is sprayed into the vapor space of the flash drum 402 and the vapor space of the stripper 404 to reduce vessel fouling and provide cooling, the spray pattern is typically either hollow cone or solid cone. The slurry concentration to the flash drum 402 and stripper 404 process units is controlled to minimize agglomeration and the propensity for plugging by, for example, controlling flow rates of the calcium and surfactant injected into the flash drums to manage the crumb size within a desirable operational parameter. Lower injection rate provides higher crumb size and vice versa.

The solvent/water in the vapor streams (line 406) from the flash drums is condensed and the solvent separated in a condenser/separator 412 and sent to storage for subsequent drying and recycle, the water is recycled in the process.

Flash drum 402 is operated at a pressure of about 140 kPaa to about 190 kPaa, and the liquid temperature is about 105° C. to about 120° C. The stripper 404 pressure can operate at a pressure of about 80 kPaa to about 130 kPaa, such as about 90 kPaa to about 120 kPaa, and the liquid temperature is about 90° C. to about 110° C. The stripper 404 pressure is controlled by vacuum pumps or vacuum jets. The stripper overheads stream (line 410) is recycled to the flash drum(s) 402 for energy conservation. In larger production facilities multiple flash drum(s) and stripper(s) may be operated in parallel. In facilities where parallel flash drum(s) and stripper(s) are employed, instrumentation can be used to ensure even flow distribution between the parallel units.

Flash drum 402 can have agitators to ensure good mixing between cement and water and to promote crumb formation such as eccentric flat blade agitators. Stripper 404 agitators to ensure good mixing of floating rubber particles in liquid include up or down pumping pitched blade turbines, up or downpumping hydrofoils.

The crumb size should be controlled in the flash drum 402 and stripper 404, because too small crumbs results in vessel and pipework fouling and difficulty dewatering/drying, whereas too large crumbs makes solvent removal difficult and may result in pipework plugging. Crumb size is controlled by calcium stearate addition, calcium stearate particle size and particle size distribution, and surfactants added with the calcium stearate. Crumb size distribution is measured and monitored, e.g., depending on downstream processing such as extruder sizing.

### Structure III Stabilizers

Bromobutyl rubber can be described as having different types of monomeric units known as structure 1, structure 2, and structure 3, etc. Structure 1 refers to unbrominated isoprene units. Structure 2 refers to isoprene units that are brominated at a carbon atom along the polymer backbone. Structure 3 refers to isoprene units that are brominated at a methyl substituent. During bromination of the butyl rubber, a bromobutyl rubber can have a high amount of formation of structure 2 units but, over time, the bromobutyl rubber that is formed begins to have undesirably high amounts of structure 3 content, at which point the bromination conditions must be analyzed and altered and/or the bromination is shut down. Ultimately, the bromobutyl rubber having high structure 3 content reduces the yield of bromobutyl rubber having high structure 2 content. High structure 3 content also results in Mooney viscosity growth of the bromobutyl rubber.

In one or more embodiments, a structure III stabilizer may be added in one or more locations in the halogenation process, such as upstream the halogenation reactor. A free-radical stabilizer, free-radical scavenger, or antioxidant, collectively referred to herein as a “structure III stabilizer”, is provided at a location upstream of the halogenation reactor. The structure III stabilizer may be organic-soluble or a water compatible compound, such as an oil-soluble compound or a hexane-soluble compound.

Suitable structure III stabilizers include sterically hindered nitroxyl ethers, sterically hindered nitroxyl radicals, butylated hydroxytoluene (BHT), hydroxyhydrocinnamite, thiodipropinoate, phosphites, and combinations thereof. Commercially available examples of structure III stabilizers that can be added during the preparation of halobutyl rubbers of the present disclosure include, but are not limited to, TEMPO, Tinuvin™ NOR 371, Irganox PS 800, Irganox 1035, Irganox 1010, Irganox 1076, Irgafos 168. TEMPO is a term generally used to refer to (2,2,6,6-tetramethylpiperidin-1-yl)oxy. The sterically hindered nitroxyl radical may be TEMPO. Tinuvin™ NOR 371 may be used which is a high molecular weight hindered amine NOR stabilizer, commercially available from BASF as a plastic additive. Irganox PS 800 may be used, which is commercially available from CIBA and is the trade name of didodecyl-3,3′-thiodipropionate. Irganox 1035 may be used and is commercially available from CIBA/BASF and is the trade name of thiodiethylene bis(3,5-di-tert-butyl-4-hydroxyhydrocinnamate). Irganox 1010 may be used which is commercially available from BASF and is the trade name of pentaerythritol tetrakis(3-(3,5-di-tert-butyl-4-hydroxyphenyl)propionate). Irganox 1076 may be used which is commercially available from CIBA and is the trade name of octadecyl-3-(3,5-di-tert.butyl-4-hydroxyphenyl)-propionate. Sterically hindered phenolics may include BHT, Irganox PS 800, Irganox 1035, or combinations thereof. Irgafos 168 may be used which is commercially available from BASF and is a general purpose phosphite. In some embodiments, other structure III stabilizers may be added to the bromobutyl-rubber of the present disclosure including, but not limited to, light stabilizers and UV-absorbers.

In an embodiment, the structure III stabilizer may be added in more than one location in the halogenation process.

In some embodiments, the total amount of structure III stabilizer to be added during the process of preparing the halobutyl rubber is greater than about 20 ppm, such as greater than 50 ppm, such as greater than 75 ppm, such as greater than 100 ppm, to less than about 500 ppm, such as less than about 400 ppm, such as less than about 300 ppm, such as less than about 200 ppm, such as less than about 150 ppm, such as less than about 100 ppm. The ppm weight basis is the weight relative to the halobutyl rubber (whether in solution, slurry, or recovered).

### Finishing

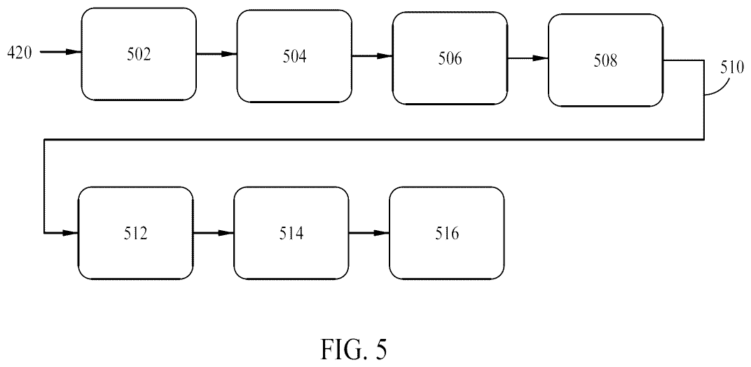

The bottoms stream at 414 from the stripper(s) containing rubber crumb and water is routed (via line 420) to an agitated slurry tank 502, as shown in FIG. 5. FIG. 5 is a diagram illustrating finishing of the crumbs. Typically pitched blade impellors or a combination of pitched blade impellors and flat blade impellors in up or downpumping mode are used.

The rubber crumb/water slurry is pumped to a dewatering screen(s) 504 to remove gross water. The rubber crumb is then fed to one or more extruders in series, such as a dewatering extruder 506 and drying extruder 508, to process the rubber crumb. The dewatering and first stage drying extruders 506, 508 may be one or more of the following: expanders, expellers, dewatering extruders, slurry dewatering units, volatiles control unit, and the like. The final stage drying extruders may be dual worm drying extruders, e.g., as described in U.S. Pat. No. 7,858,735 incorporated by reference herein. The temperatures and pressures in the extruders are controlled by adjusting the restriction at the extruder outlet typically with a fixed or variable die plate. Heat may be added by steam jacketing the extruders. Inert gas may be injected to improve drying, as described in U.S. Pat. No. 4,508,592 incorporated herein by reference. Polymer additives are injected at various stages of the extrusion process to meet product specifications and depending on the grade may include none, one, or more of the following polymer additives: epoxidized soy bean oil, calcium stearate butylated hydroxytoluene, Irganox, or antioxidants.

The crumbs from the final drying extruder are then transported (line 510) to a fluidized bed conveyor 512 for drying to product specification, the rubber crumb may be transported by mechanical conveyors. In some embodiments, the fluidized bed conveyor 512 has 2 sections consisting of a primary hot section for drying the crumbs and secondary cool section to cool the crumbs. The crumbs from the fluidized bed conveyor 512 are then routed to a packaging unit 514 where the crumb is compacted into bales, packaged and quality checked. The final rubber polymer product at 516 is stored in warehouse for distribution to customers. Large production facilities operate multiple extrusion and fluidized bed drying lines in parallel. The solvent vapors from the slurry tank, the extruders and fluidized bed conveyors may be captured in an air collection system for treatment.

Rubber fines are removed from finishing water recovered from the dewatering screens and extruders for recycle or disposal. The finishing water with fines removed is recycled to the reslurry and halogenation unit with excess water purged from the process. The excess water will be further treated at the facility before final disposal. Additional antifouling and additives may be added to the recycled water to reduce fouling and control pH. The additives may include but not exclusively none, one or more of: calcium chloride, proprietary antifoulants, e.g. PETROFLO™ or borate based buffers.

For some embodiments involving halogen regeneration, additives, including epoxidized soybean oil (also referred to as ESBO) and calcium stearate, may be added during the regenerative process. For example, ESBO may be added in the range of about 1 to about 2 phr in drying extruder 508 before or during the drying. Additionally or alternatively, calcium stearate may be added to the cement during neutralization, and/or may be added to the flash drum to help the polymer from sticking to the equipment and to control the rubber particle size in the water slurry.

In some embodiments, an additive, such as ESBO, may be added to stripper 404 and/or line 414.

### Physical Properties of Halobutyl Elastomers

The physical and mechanical properties of halobutyl elastomers described herein can be incorporated into a typical inner liner formulation to determine the physical and mechanical properties of such materials. In some embodiments, halobutyl elastomers produced from methods detailed herein (after compounding) have an initial Modulus (as determined by ASTM D412) of about 9.5 MPa to about 10.3 MPa, such as about 9.6 MPa to about 10.2 MPa, such as about 9.7 MPa to about 10 MPa. In one or more embodiments, halobutyl elastomers of the present disclosure (after compounding) exhibit an initial elongation at break (as determined by ASTM D412) of about 775% to about 825%, such as about 785% to about 815%, such as about 800% to about 810%. In one or more embodiments, halobutyl elastomers of the present disclosure (after compounding) exhibit an initial tear strength (as determined by ASTM D624) of about 34.1 N/mm to about 37.5 N/mm, such as about 35 N/mm to about 37 N/mm, such as about 35 N/mm to about 36 N/mm. In one or more embodiments, halobutyl elastomers of the present disclosure (after compounding) exhibit an initial hardness value (as determined by ASTM D2240) of about 45 to about 46.

Halobutyl elastomers disclosed herein can be subject to intentional aging processes to provide information pertaining to long term thermal and mechanical stability of the materials. Without being bound by theory, it is believed that there can often be a time-temperature correlation for aged Mooney viscosity, such that aging at a lower temperature for a longer time period can be roughly equivalent to aging at a higher temperature for a shorter time. For example, in some embodiments, it is believed that an aged Mooney viscosity measured after approximately 7 days' exposure to about 80° C. can be roughly equivalent to that measured after approximately 21 months' exposure to about 33° C. Further, such thermally induced viscoelastic changes would correspond to changes in physical and mechanical properties.

In some embodiments, aged halobutyl elastomers produced from methods detailed herein have an aged Modulus (as determined by ASTM D412) of about 7.9 MPa to about 8.65 MPa when aged for 7 days at about 80° C., such as about 8.45 MPa to about 8.6 MPa, such as about 8.45 MPa to about 8.55 MPa. In one or more embodiments, aged halobutyl elastomers of the present disclosure exhibit an aged elongation at break (as determined by ASTM D412) of about 500% to about 650% when aged for 7 days at about 80° C., such as about 550% to about 625%, such as about 575% to about 620%. In one or more embodiments, aged halobutyl elastomers of the present disclosure exhibit an aged tear strength (as determined by ASTM D624) of about 33.5 N/mm to about 36 N/mm when aged for 7 days at about 80° C., such as about 34 N/mm to about 36 N/mm, such as about 35 N/mm to about 36 N/mm. In one or more embodiments, aged halobutyl elastomers of the present disclosure exhibit an aged hardness value (as determined by ASTM D2240) of about 55 to about 58 when aged for 7 days at about 80° C.

In some embodiments, halobutyl elastomers produced from the process detailed above, exhibit an initial Mooney viscosity (as determined by ASTM D1646 at 100° C.) of about 30 Mooney units (MU) to about 35 MU, such as about 31 MU to about 33 MU, such as about 31 MU to about 32 MU. Further, halobutyl elastomers of the present disclosure exhibit a Mooney viscosity of about 32.5 MU to about 35.5 MU when aged for 7 days at about 80° C., such as about 33 MU to about 35 MU, such as about 34.5 MU to about 33.5 MU. In some embodiments, the halobutyl elastomers of the present disclosure exhibit a change in Mooney viscosity of about 2.5 MU to about 5 MU, such as about 2.5 MU to about 3.5 MU when aged for 7 days at about 80° C., such as about 2.5 MU to about 3.2 MU, such as about 2.5 MU to about 2.7 MU.

### Industrial Applicability

The brominated elastomer compositions disclosed herein can be used to make any number of articles. In certain embodiments, the article is selected from tire curing bladders, tire innerliners, tire innertubes, and air sleeves. In some embodiments, the article is a hose or a hose component in multilayer hoses, such as those that contain polyamide as one of the component layers. Other useful goods that can additionally or alternatively be made using polymers of the present disclosure include air spring bladders, seals, molded goods, cable housing, rubber-based pharmaceutical stoppers, and other articles disclosed in THE VANDERBILT RUBBER HANDBOOK, PP. 637-772 (Ohm, ed., R.T. Vanderbilt Company, Inc., 1990).

### Environmental and Safety Considerations

The processes described herein provide several benefits not normally realized by current commercial processes. In fact, processes disclosed herein provide additional safety, environmental, and raw material conservation implications not provided by previous processes and applications. For example, processes disclosed herein can result in a 30% reduction in bromine deliveries (liquid and/or gas phase), thereby increasing personal and environmental safety by reducing handling of hazardous materials. Additionally or alternatively, processes disclosed herein can reduce the use and re-use of bromine/bromide and reduce the total amount of dissolved solids (e.g., bromide salts) present in the industrial waste water stream, as determined by gravimetric analysis. In some embodiments, processes disclosed herein reduce the total amount of dissolved solids (e.g., bromide salts) present in the industrial waste water stream by about 45% to about 65% when compared to conventional processes, such as about 50% to about 60%. In one or more embodiments, the industrial waste water stream derived from processes disclosed herein includes about 2,000 mg/L to about 2,650 mg/L of dissolved solids (e.g., bromide salts), such as 2,015 mg/L to about 2,645 mg/L. Without being bound by theory, such reduction in waste solids present in the industrial waste water stream is realized by reducing the input bromine requirements for such halogenation reactions (as exemplified through the respective hydrogen peroxide to Br₂ ratio and/or Br₂ rubber ratio). As a result, the processes disclosed herein can be attributed with increased personal and environmental safety and increased conservation of raw materials.

### EXAMPLES

Mooney viscosity

The Mooney viscosity of the elastomers and the compounds was tested using an MV-2000 instrument (Alpha Technologies) according to ASTM Standard D 1646 by using large rotors. The elastomers were tested at 125° C. with a 1 min pause before the rotor starts rotating and 8 min of test time. The Mooney viscosity for elastomers was calculated at 8 min and is reported as ML1+8 @125° C. For compounds, the test was conducted at 100° C. with a 1 min pause before the rotor starts rotating and 4 min of test time; Mooney viscosity results are reported as ML1+4 @100° C. These methods were set up using the Enterprise software (Alpha Technologies) to report these values at the end of testing.

### Nuclear Magnetic Resonance Spectroscopy (NMR)

¹H NMR spectra were obtained on a DD2 500 MHz spectrometer (Agilent) with a 5 mm H/F probe at 25° C. A tip angle of 30° was used with a 5 s delay and 128 transients by using standard 5 mm tubes at room temperature. Polymer samples were dissolved at a concentration of 30 mg/mL in 1, 1, 2, 2-tetrachloroethane-d2.

### Fourier Transform Infrared Spectroscopy (FTIR)

The quantification of the bromide functional structures (Str I, II, and III), in the elastomer, and other components or additives present were determined using a PerkinElmer Frontier FTIR spectrometer with triglycine sulfate (TGS) detector and a sample shuttle. The spectrometer was controlled by PerkinElmer Spectrum™ 10.6.0 software. The infrared spectra of elastomers were acquired using a compression molded film specimen of 0.06 cm thickness, using an automated hydraulic press (Carver). FTIR spectra were collected at 4 cm⁻¹ resolution with 16 scans, scan range 6525-400 cm¹. All FTIR spectra were normalized against a common region 4400-4250 cm⁻¹, and the base absorbance was measured at 4980-2040 cm⁻¹.

x-Ray Fluorescence Spectroscopy (XRF)

Elemental analyses were performed using a spectrometer with a chromium X-ray tube (Panalytical Axios). For X-ray fluorescence spectrometry (XRF), the setup was capable of analyzing Br, Ca, and low levels of Fe by using calibration standards prepared with the same polymer matrix. XRF testing was conducted on molded elastomer disks with a smooth surface, molded using a metallic ring (thickness, 0.5 in. [2.54 cm]; and diameter, 2 in. [5.08 cm]) at 120° C. for 5 min and 11000 kPa (1600 psi) followed by 5 min at 11,000 kPa (1600 psi) in a cooled press. Three samples were tested, and the average value is reported.

### Material Preparation and Processing

Halobutyl rubber specimens were prepared using a conventional regenereative bromination process (such as that disclosed in U.S. Pat. No. 5,670,582). Tables 1 and 2 summarize various processing parameters and processing data used herein. The peroxide to bromine molar ratios were maintained at about 0.4 to about 0.6 (mol:mol) for the trial runs that were to be compared to the control runs. The ratio of bromine to rubber was adjusted to maintain the target range of total wt % bromine and/or functional bromine covalentely bound to the polymer backbone. As such the bromine utilization ranged between about 60% to about 80%, and can be further increased with greater peroxide to bromine molar ratios and greater residence times. Undesired brominated species and acidic species were monitored and minimized through sufficient addition of 10% caustic soda solution to maintain a pH of about 9 to about 10 and a minimum molar ratio of caustic soda to unreacted bromine of about 2.2.

TABLE 1
Bromobutyl rubber processing conditions and data (experiment 1)

| | | Control- | Control- | Control- | Trial- | Trial- | Trial- | Trial- | Trial- |
|---|---|---|---|---|---|---|---|---|---|
| Processing Data | Units | 1 | 2 | 3 | 1 | 2 | 3 | 4 | 5 |
| Residence Time | min | 1.42 | 2 | 1.35 | 2.71 | 1.34 | 1.28 | 3 | 2.7 |
| Cement concentration | wt % | 29.8 | 22.3 | 28.3 | 27.8 | 29 | 28.9 | 27.2 | 27.7 |
| Hydrogen Peroxide to | mol:mol | 0 | 0 | 0 | 0.5 | 0.4 | 0.4 | 0.39 | 0.6 |
| Br₂ Ratio | | | | | | | | | |
| Br₂ to Rubber Ratio | kg/Ton | 38.1 | 40.6 | 38.4 | 28.2 | 30.4 | 30.2 | 29 | 28.6 |
| Bromination Temp | ° C. | 61.4 | 51.7 | 58.9 | 59.6 | 59.9 | 59.3 | 56.8 | 55.4 |
| Br₂ Utilization | wt % | 51.1 | 47.1 | 50.7 | 72.5 | 63.8 | 63.8 | 68 | 76.3 |

TABLE 2
Bromobutyl rubber processing conditions and data (experiment 2)

| | | Control- | Control- | Control- | Trial- | Trial- | Trial- |
|---|---|---|---|---|---|---|---|
| Processing data | Units | 1 | 2 | 3 | 1 | 2 | 3 |
| Residence Time | min | 1.6 | 3.1 | 3.4 | 3.1 | 3.1 | 22.5 |
| Cement concentration | wt % | 21.3 | 23.9 | 24 | 24 | 24 | 24 |
| Hydrogen Peroxide to Br₂ Ratio | mol:mol | 0 | 0 | 0 | 0.4 | 0.6 | 0.6 |
| Br₂ to Rubber Ratio | kg/Ton | 42.8 | 42.4 | 41 | 30.5 | 29 | 25 |
| Bromination Temp | ° C. | 60 | 57.9 | 58.2 | 60.3 | 58.2 | 58.8 |
| Br₂ Utilization | wt % | 44 | 44 | 44 | 69.6 | 75.9 | 82.6 |

Interestingly, it was found that the surfactant plays a critical role in promoting H₂O₂ utilization in the regenerative bromination process. It was found that at a peroxide to bromine molar ratio of 0.2 H₂O₂:Br₂, a negligible negative impact of H₂O₂ conversion was observed without the use of surfactant and surfactant injection in the regenerative process as the H₂O₂ conversion was calculated to be about 90% based on measured O₂ in the system vent gas. However, when the peroxide to bromine molar ratio of 0.4 H₂O₂:Br₂ a significant decrease in H₂O₂ conversion was observed without the use of surfactant or surfactant injection, as the conversion was calculated to be about 60%. When surfactant flow was established or re-established, H₂O₂ conversion immediately increased to nearly 100% without any other process interventions. Without being bound by theory, the surfactant assists in forming a more stable dispersion (e.g., heterophasic mixture) in the halogenation reactor 314. Thus, aqueous H₂O₂ is able to be well dispersed within the continuous hydrocarbon phase (e.g., cement). Additionally, a more stable dispersion allows for increased surface area between the aqueous and hydrocarbon phase, which in turn promotes migration of HBr from the hydrocarbon phase to the aqueous phase halogen regeneration.

### Functional Bromine Determination

FTIR spectral regions corresponding to structures and/or components of interest were correlated with NMR data using a PLS model to determine the amount functional bromine in the brominated polymer product. The calibration sets were prepared from standards with known concentration obtained by NMR, and a macro model was developed to automatically calculate the mol % of the bromide structures after the spectrum was collected. The resulting values are summarized in Tables 3 and 4.

TABLE 3
Functional bromine content (experiment 1)

| | | Control- | Control- | Control- | Trial- | Trial- | Trial- | Trial- | Trial- |
|---|---|---|---|---|---|---|---|---|---|
| | Units | 1 | 2 | 3 | 1 | 2 | 3 | 4 | 5 |
| Total | wt % | 1.92 | 1.97 | 1.94 | 2.05 | 1.95 | 1.92 | 1.99 | 2.07 |
| Bromine | | | | | | | | | |
| Functional | mol % | 1.02 | 1.03 | 1.03 | 1.04 | 1.04 | 1.01 | 1 | 1.06 |
| Bromine | | | | | | | | | |
| Str-III | mol % | 0.07 | 0.1 | 0.07 | 0.12 | 0.07 | 0.08 | 0.12 | 0.12 |
| Total | mol % | 1.55 | 1.52 | 1.55 | 1.5 | 1.53 | 1.55 | 1.52 | 1.54 |
| Unsaturation | | | | | | | | | |

TABLE 4
Functional bromine content (experiment 2)

| | Units | Control-1 | Control-2 | Control-3 | Trial-1 | Trial-2 | Trial-3 |
|---|---|---|---|---|---|---|---|
| Total Bromine | wt % | 1.95 | 2.04 | 1.97 | 1.95 | 2 | 1.98 |
| Functional Bromine | mol % | 0.98 | 1 | 0.99 | 0.99 | 1.01 | 0.98 |
| Str-III | mol % | 0.08 | 0.08 | 0.08 | 0.1 | 0.1 | 0.08 |
| Total Unsaturation | mol % | 1.55 | 1.56 | 1.57 | 1.53 | 1.51 | 1.55 |

As shown in Tables 3 and 4, experiments 1 and 2 yield bromobutyl elastomers with comparable bromine conent and structure.

TABLE 5
Residual salt content content present in resulting waste water (experiment 2)

| | Bromination | | mg/L | mg/L |
|---|---|---|---|---|
| Sample ID | Rate | Process Condition | Bromide | Chloride |
| Experiment 2 - | 8.8 | Conventional | 5112 | 149 |
| control 2 | | | | |
| Experiment 2 - Trial | 8.8 | Regen, 3.1 min RT, 0.6 H2O2, 24% | 2022 | 74 |
| 2 | | Conc. | | |
| Experiment 2 - Trial | 14 | Regen, 1.9 min RT, 0.6 H2O2, 24% | 2644 | 73 |
| 3 | | Conc. | | |
| Experiment 2 - | 14 | Conventional | 5512 | 55 |
| control 3 | | | | |

As shown in Table 5, the halogen regeneration process of experiment 2 results in reduced salt content being removed via the waste water produced from processes disclosed herein. Such reduction in the salt content (e.g., bromide salt) found within the produced waste water further exemplifies the reduction in risk of environmental impact of such processes.

### Mooney Viscosity Determination

Initial Mooney viscosities were measured on brominated butyl elastomer samples within an hour after being isolated. Samples of brominated butyl elastomers were aged in an air circulating oven at 80° C. for about 7-10 days. The samples aged at 80° C. for 5 days are expected to exhibit properties similar to bromobutyl elastmers in warehouse conditions for 1 year. The samples aged at 80° C. for 7 days are expected to exhibit properties like bromobutyl elastomers in warehouse conditions for 2 years. Samples were taken in intervals of 0, 1, 3, 7, 10, etc. days at 80° C. and tested for Mooney viscosity in accordance with ASTM 1646. The change in Mooney viscosity was calculated to determine the change in Mooney viscosity with aging. Aged Mooney viscosities were measured on isolated brominated butyl elastomer samples both before and after oven aging at a temperature of about 80° C. for about 7 days (simulation of lengthy storage condition accelerated by using higher-than-ambient temperature). Table 2 summarizes the Mooney viscosity for each of the test samples throughout the aging process at varying time intervals. Table 3 summarizes the change in Mooney viscosity for each of the test samples throughout the aging process at varying time intervals.

TABLE 5
Mooney viscosity throughout aging process (experiment 1)

| Days | Mooney Viscosity (MU) | | | | | | | |
|---|---|---|---|---|---|---|---|---|
| Aged | Control- | Control- | Control- | Trial- | Trial- | Trial- | Trial- | Trial- |
| (80° C.) | 1 | 2 | 3 | 1 | 2 | 3 | 4 | 5 |
| 0 | 32 | 32 | 32.5 | 32.3 | 31.7 | 31.4 | 30.9 | 30.4 |
| 1 | 32.9 | 32.7 | 33.4 | 32.8 | 32.2 | 31.7 | 31.7 | 30.9 |
| 5 | 34.3 | 34.5 | 35 | 34.8 | 33.9 | 33.4 | 33.4 | 32.4 |
| 7 | 35.2 | 35.2 | 35.2 | 35 | 34.2 | 33.9 | 34.1 | 32.9 |

TABLE 6
Change in Mooney viscosity throughout
aging process (experiment 1)

| Days | Change in Mooney Viscosity (MU) | | | | | | | |
|---|---|---|---|---|---|---|---|---|
| Aged | Control- | Control- | Control- | Trial- | Trial- | Trial- | Trial- | Trial- |
| (80° C.) | 1 | 2 | 3 | 1 | 2 | 3 | 4 | 5 |
| 0 | 0 | 0 | 0 | 0 | 0 | 0 | 0 | 0 |
| 1 | 0.9 | 0.7 | 0.9 | 0.5 | 0.5 | 0.3 | 0.8 | 0.5 |
| 5 | 2.3 | 2.5 | 2.5 | 2.5 | 2.2 | 2 | 2.5 | 2 |
| 7 | 3.2 | 3.2 | 2.7 | 2.7 | 2.5 | 2.5 | 3.2 | 2.5 |

TABLE 7
Mooney viscosity throughout aging process (experiment 2)

| Days | | | | | | |
|---|---|---|---|---|---|---|
| Aged | Mooney Viscosity (MU) | | | | | |
| (80° C.) | Control-1 | Control-2 | Control-3 | Trial-1 | Trial-2 | Trial-3 |
| 0 | 33 | 33.4 | 32.5 | 31.9 | 32.3 | 32.8 |
| 1 | 32.9 | 32.9 | 32.2 | 32 | 31.8 | 32.4 |
| 5 | 34.3 | 34.3 | 33.3 | 33.4 | 33.5 | 34.3 |
| 7 | 35.6 | 35.1 | 35.7 | 33.8 | 34.6 | 35.4 |

TABLE 8
Change in Mooney viscosity throughout
aging process (experiment 2)

| Days | | | | | | |
|---|---|---|---|---|---|---|
| Aged | Change in Mooney Viscosity (MU) | | | | | |
| (80° C.) | Control-1 | Control-2 | Control-3 | Trial-1 | Trial-2 | Trial-3 |
| 0 | 0 | 0 | 0 | 0 | 0 | 0 |
| 1 | −0.1 | −0.5 | −0.3 | 0.1 | −0.5 | −0.4 |
| 5 | 1.3 | 0.9 | 0.8 | 1.5 | 1.2 | 1.5 |
| 7 | 2.6 | 1.7 | 3.2 | 1.9 | 2.3 | 2.6 |

It was determined that the Mooney stability of the halobutyl elastomers developed via processes disclosed herein is similar to that of those from from conventional processes. In other words, the Mooney viscosity growth of halobutyl elastomers produced from regenerative halogenation processes disclosed herein is comparable to that of those from conventional processes (as exemplified in Tables 6 and 8). Thus, even with the low residence times and high concentration of brominated cement, the regenerated product from processes disclosed herein did not show elevated Mooney viscosity growth (also referred to as Mooney march) when compared against the control samples for all regeneration conditions.

### Inner Liner Compound Mixing

Compounds for application studies and physical and mechanical property evaluations were prepared using a typical inner liner formulation (Table 9), prepared using a Banbury mixer. The mixing was conducted in a 1.6 liters Banbury mixer with a fill factor of 80% and a rotor speed of 70 rpm. The density of the master batch was ˜1.11 g/cc, hence, the batch weights were 1423 grams for nonproductive (NP) masterbatch and final mix. The polymer (or polymers) was introduced into the mixer at time, t=0 and masticated for 30 seconds; at time, t=30 seconds, ⅔ carbon black was added, t=120 seconds chemicals (tackifier, homogenizing resin, scorch retarder, oils) were added; this was followed by a ram sweep clean cycle at time, t=210 seconds; the NP masterbatch was discharged at 135° C. The total NP mixing time was approximately 5 minutes; in all cases the mix was discharged to time controlled. For the final batch, the fill factors were kept at ˜77% and the rotor speed was kept at 40 rpm. For the preparation of the final batch, the masterbatch and curatives (zinc oxide, sulfur, MBTS) was charged to the mixer at time t=0; at time, t=60 seconds a ram sweep was given. The final batch was discharged at <100° C. The total final batch mixing times were 2 minutes. The discharge from the mixer was passed thru a two-roll mill twice to prepare thick pads. The sheeted rubber compound was used to prepare test samples for properties evaluations.

TABLE 9
Typical formulation used for inner liner components

| Ingredients | phr |
|---|---|
| Bromobutyl rubber | 100 |
| N 660 | 60 |
| IPOL 501 | 8 |
| Stearic acid | 1 |
| Struktol ® 40 MS | 7 |
| Escorez ™ 1102 | 4 |
| MgO | 0.15 |
| Zinc Oxide, ZnO | 1 |
| MBTS | 0.5 |
| Sulphur | 1.25 |

### Physical and Mechanical Properties

Material hardness was measured in accordance to ASTM D2240. The arithmetic mean of five samples are reported for the original, steam aged, and heat aged specimens. Material mechanical properties were measured in accordance with ASTM D412, wherein an average of three specimens of a compound were reported for the original, heat aged, and steam aged samples. Material tear strength was determined in accordance with ASTM D624, wherein an average of three specimens of a compound were reported for the original, heat aged, and steam aged samples. Samples were tested both before and after oven aging at a temperature of about 125° C. for about 3 days (simulation of lengthy storage condition accelerated by using higher-than-ambient temperature).

Physical and mechanical properties of halobutyl elastomers disclosed herein were determined both before and after material aging to determine material property retention. Such physical and mechanical properties are summarized in Tables 10 and 11.

TABLE 10
Physical and mechanical properties throughout aging process (experiment 1)

| | | Control- | Control- | Control- | Trial- | Trial- | Trial- |
|---|---|---|---|---|---|---|---|
| | units | 1 | 2 | 3 | 1 | 2 | 3 |
| Tensile Strength - 0 d | MPa | 9.7 | 9.8 | 9.7 | 10.0 | 9.7 | 9.6 |
| Tensile Strength - 3 d | MPa | 8.60 | 8.62 | 8.61 | 8.46 | 8.53 | 8.41 |
| Elongation at Break - 0 d | % | 777 | 788 | 800 | 804 | 808 | 809 |
| Elongation at Break - 3 d | % | 619.89 | 596.76 | 598.45 | 548.37 | 617.20 | 576.85 |
| Tear Strength - 0 d | N/mm | 36.6 | 37.1 | 35.0 | 35.7 | 35.9 | 35.1 |
| Tear Strength - 3 d | N/mm | 35.68 | 34.89 | 33.78 | 34.47 | 34.17 | 34.49 |
| Hardness - 0 d | Shore A | 45.00 | 45.00 | 45.00 | 46.00 | 45.00 | 45.00 |
| Hardness - 3 d | Shore A | 57.00 | 57.00 | 56.00 | 58.00 | 58.00 | 57.00 |

TABLE 11
Physical and mechanical properties throughout aging process (experiment 2)

| | | Control- | Control- | Control- | Trial- | Trial- | Trial- |
|---|---|---|---|---|---|---|---|
| | units | 1 | 2 | 3 | 1 | 2 | 3 |
| Tensile Strength - 0 d | MPa | 10.3 | 9.8 | 10.2 | 10.1 | 10.1 | 10.0 |
| Tensile Strength - 3 d | MPa | 8.4 | 7.9 | 8.2 | 8.2 | 8 | 8.4 |
| Elongation at Break - 0 d | % | 820 | 790 | 820 | 820 | 790 | 820 |
| Elongation at Break - 3 d | % | 640 | 630 | 620 | 640 | 590 | 660 |
| Tear Strength - 0 d | N/mm | 36.9 | 36.8 | 36.8 | 35.8 | 34.1 | 36.0 |
| Tear Strength - 3 d | N/mm | 34.3 | 34.2 | 35.9 | 34.7 | 34.8 | 34.3 |
| Hardness - 0 d | Shore | 46 | 46 | 46 | 45 | 45 | 46 |
| | A | | | | | | |
| Hardness - 3 d | Shore | 55 | 55 | 56 | 57 | 56 | 55 |
| | A | | | | | | |

It has been determined that, physical and mechanical properties and property retention of halobutyl elastomers prepared by processes disclosed herein are comparable to conventional halogenation processes (as exemplified in Tables 10 and 11).

Overall, the regenerative halogenation process disclosed herein provides a simple yet efficient route to developing halobutyl elastomers with comparable Mooney viscosity growth and physical property retention to elastomers formed from conventional halogenation processes. In addition, stable dispersions in the halogenation reactor can be achieved. Processes disclosed herein allow for low residence times and high concentrations of halogenated cement without affecting the Mooney stability of the halobutyl elastomers.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A process comprising:
introducing an aqueous solution with a first hydrocarbon solvent to form an emulsion, wherein the aqueous solution comprises an oxidizing agent and a surfactant;
introducing a cement with the emulsion to form a first mixture within a reactor, wherein the cement comprises a butyl rubber elastomer and a second hydrocarbon solvent that is the same as or different than the first hydrocarbon solvent;
introducing a halogen source with the first mixture contained within the reactor to form a second mixture comprising a halobutyl rubber elastomer;
introducing a neutralizing agent with the second mixture to form a third mixture; and
isolating the halobutyl rubber elastomer from the third mixture.

2. The process of claim 1, wherein the oxidizing agent containing solution is an aqueous solution comprising about 30 wt % to about 40 wt % oxidizing agent.

3. The process of claim 1, wherein the surfactant comprises an ethoxylated alcohol emulsifying agent.

4. The process of claim 2, wherein the oxidizing agent is hydrogen peroxide.

5. The process of claim 1, wherein the aqueous solution comprises an input ratio of surfactant to oxidizing agent of about 1:100 (lbs surfactant:lbs oxidizing agent) to about 3.8:100.

6. The process of claim 1, wherein the first hydrocarbon solvent is selected from the group consisting of pentane, hexane, heptane, and combinations thereof.

7. The process of claim 1, wherein the formation of the second mixture comprises a halogenation reaction between the halogen source and the first mixture contained within the reactor for a residence time of about 0.5 min to about 60 min.

8. The process of claim 1, wherein the butyl rubber elastomer comprises about 18 wt % to about 35 wt % of the cement.

9. The process of claim 1, wherein the second hydrocarbon solvent is selected from the group consisting of pentane, hexane, heptane, and combinations thereof.

10. The process of claim 1, wherein the halogen source is Br₂.

11. The process of claim 10, wherein the peroxide to bromine ratio (mol:mol) is about 0.3:1 to about 0.8:1.

12. The process of claim 10, wherein the bromine to rubber ratio is about 18 kg/Ton to about 45 kg/Ton.

13. A process, comprising:
introducing an aqueous solution with a first organic solvent to form an emulsion, wherein the aqueous solution comprises an oxidizing agent and a surfactant;
introducing a cement with the emulsion to form a first mixture in a reactor, wherein the cement comprises a butyl rubber elastomer and a second organic solvent;
introducing a halogen source with the first mixture contained in the reactor to form a second mixture, wherein forming the second mixture further comprises conducting a halogenation reaction comprising:
reacting the halogen source with the butyl rubber elastomer to form an initial halogenated butyl rubber elastomer and a hydrogen halide,
reacting the hydrogen halide with the oxidizing agent to form a free halide, and
continuing the halogenation reaction to produce additional halobutyl rubber elastomer;
introducing a neutralizing agent with the second mixture to form a third mixture; and
isolating the initial halobutyl rubber elastomer and/or the additional halobutyl rubber elastomer from the third mixture.

14. The process of claim 13, wherein the halogen source is Br₂.

15. The process of claim 14, wherein the bromine utilization of the halogenation reaction is about 60% to about 90%.

16. The process of claim 14, wherein the the residence time of the halogenation reaction is about 1 min to about 25 min.

17. The process of claim 14, wherein the temperature of the halogenation reaction is about 20° C. to about 70° C.

18. The process of claim 14, wherein the halobutyl elastomers have an initial Mooney viscosity (as determined by ASTM D1646) of about 20 MU to about 50 MU.

19. The process of claim 14, wherein the halobutyl elastomers have an increase in Mooney viscosity (as determined by ASTM D1646) of about 2.5 MU to about 5 MU when aged for 7 days at about 80° C.

20. A process comprising:
introducing an aqueous solution with a first hydrocarbon solvent to form an emulsion, wherein the aqueous solution comprises an oxidizing agent and a surfactant;
introducing a cement to the emulsion to form a first mixture within a reactor, wherein the cement comprises a butyl rubber elastomer and a second hydrocarbon solvent that is the same as or different than the first hydrocarbon solvent;
introducing HBr into the reactor containing the first mixture to form a second mixture comprising a halobutyl rubber elastomer;
introducing a neutralizing agent with the second mixture to form a third mixture; and
isolating the halobutyl rubber elastomer from the third mixture.

21. A process, comprising:
introducing an aqueous solution with a first organic solvent to form an emulsion, wherein the aqueous solution comprises an oxidizing agent and a surfactant;
introducing a cement with the emulsion to form a first mixture in a reactor, wherein the cement comprises a butyl rubber elastomer and a second organic solvent;
introducing a halogen source with the first mixture contained in the reactor to form a second mixture such the molar ratio of oxidizing agent to halogen is about 0.2:1 to about 0.8:1, wherein forming the second mixture further comprises conducting a halogenation reaction comprising:
reacting the halogen source with the butyl rubber elastomer to form an initial halogenated butyl rubber elastomer and a hydrogen halide,
reacting the hydrogen halide with the oxidizing agent to form a free halide, and continuing the halogenation reaction to produce additional halobutyl rubber elastomer;
introducing a neutralizing agent with the second mixture to form a third mixture; and
isolating the initial halobutyl rubber elastomer and/or the additional halobutyl rubber elastomer from the third mixture to form a waste mixture, wherein the waste mixture comprises about 2,000 mg/L to about 2,650 mg/L of dissolved solids.
